(19) United States
(12) Patent Application Publication
(10) Pub. No.: US 2026/0201738 A1
(43) Pub. Date: Jul. 16, 2026

(54) Sliding door gear

(71) Applicant: SAMET KALIP VE MADENI ESYA SANAYI VE TICARET A.S, Istanbul (TR)

(72) Inventors: Artur Hirtsiefer, Neunkirchen-Seelscheid (DE); Himmet Tanriverdi, Istanbul (TR); Evren Urak, Istanbul (TR)

(21) Appl. No.: 19/136,094

(22) PCT Filed: Feb. 15, 2023
(86) PCT No.: PCT/TR2023/050149

§ 371 Date: Jun. 5, 2025

(51) Int. Cl. E05D 15/56

(52) U.S. Cl. CPC E05D 15/56; E05Y 2201/628; E05Y 2201/684; E05Y 2900/20

(57) ABSTRACT

The invention relates to a sliding door gear comprising at least one door mount (40, 51) for mounting of at least one sliding door (2) to a stationary structure. Smaller achievable gap dimensions between sliding doors as well as lower manufacturing and assembly requirements are achieved in that first guide means (11, 11′) comprising a movable guide segment (11.1, 11.1′) and at least one stationary guide segment (11.2, 11.2′) are provided on which first guide elements (43, 43′) associated with the door mount (40, 51) are guided in a second opening direction D2, and in that the movable guide segment (11.1, 11.1′) is coupled to an extension/retraction device (9, 9′) that enables movement of the movable guide segment (11.1, 11.1′) in a first opening direction (D1). The invention further relates to a stationary structure comprising a sliding door gear and to a method for opening and/or closing a sliding door.

The invention relates to a sliding door gear comprising at least one door mount for mounting of at least one sliding door to a stationary structure, such as a door frame or a piece of furniture, in particular a cabinet, wherein the door mount can be moved from a closed position to an open position via an intermediate position, wherein the door mount can be moved from the closed position to the intermediate position in a first opening direction, wherein the door mount can be moved from the intermediate position to the open position in a second opening direction transverse to the first opening direction, wherein the sliding door gear comprises a sliding device enabling movement of the door mount in and/or against the second opening direction, wherein the sliding device comprises first guide means, in particular a first guide rail, on which first guide elements associated with the door mount are guided so as to be movable in and/or against the second opening direction.

A sliding door gear is known from WO 2021/173088A1 . The sliding door gear is mounted on top of a cabinet and comprises moving parts that are displaceable along a linear guide comprising two parallel rails. The moving parts comprise a first slide that is slidable along the linear guide and a second slide that is slidable in a direction perpendicular thereto. A sliding door of the cabinet is connected to the second slide via a connecting element. The second slide is guided by means of a further guide disposed between the two rails of the linear guide and that comprises an inclined portion that provides a guide curve for a roller mounted on the second slide. When a moving part reaches this inclined portion, the second slide follows the inclination and is retracted with respect to the first slide. In the closed state, the second slide and therefore the sliding door is retracted. To open the sliding door, the second slide and the sliding door will follow the inclined portion and thereby perform a motion facing away from the cabinet. When the inclined portion has been left, the sliding door can be moved parallel to the cabinet to be opened.

One disadvantage of the known design is that, due to the curved inclined portion, the door mount, and consequently the door, performs a combined motion in a first opening direction facing away from the cabinet and in a second opening direction perpendicular thereto during opening. In other words, while extending the door from the retracted (closed) position, there will always be a sidewards motion, i.e., a motion at least partially towards a neighboring sliding door due to the curved design of the inclined portion. Therefore, a sufficient gap must be provided between neighboring sliding doors in order to allow for this motion. However, for esthetic reasons, it may be desired to minimize gaps between sliding doors.

Further, to allow the combined motion in the first and the second opening direction, the known sliding door gear makes use of complex mechanisms involving interacting moving parts, e.g., separate slides. These parts need to be manufactured and assembled to a high degree of accuracy in order to work reliably.

It is the task of the invention to provide a sliding door gear that allows smaller achievable gap dimensions between sliding doors as well as lower manufacturing and assembly requirements.

It is a further task of the invention to provide a stationary structure, such as a door frame or a piece of furniture, in particular a cabinet, comprising a sliding door gear that allows smaller achievable gap dimensions between sliding doors as well as lower manufacturing and assembly requirements.

Yet another task of the invention is to provide a method for opening and/or closing a sliding door by means of a sliding door gear or a set of sliding door gears, wherein a smaller gap between sliding doors can be achieved.

The task regarding the sliding door gear is solved in that the first guide means comprise a movable guide segment and at least one stationary guide segment, in that the movable guide segment is coupled to an extension/retraction device that enables movement of the movable guide segment in and/or against the first opening direction, such that movement of the door mount between the closed and the intermediate position is enabled by the extension/retraction device.

The inventors have found that it is advantageous to decouple the extension movement, i.e. the movement in the first opening direction, from the sliding movement in the second opening direction transverse thereto. By decoupling these movements, a very small gap can be achieved between sliding doors.

Further, because the movements can be decoupled, movable parts of the sliding door gear can be designed in a much simpler fashion. It is thus not necessary to provide for moving parts that are able to move in more than one direction, e.g., to move in the first opening direction and in the second opening direction. Rather, simple mechanical means can be used like a single dedicated linear guide for each of the opening directions.

Further, the inventors have found that by decoupling the movements, the available mounting space can be used more effectively. Typically, sliding door gears may be mounted on top and/or at the bottom of a stationary structure, such as a cabinet. In these situations, there may not be very strict restrictions on the available space, as these areas generally provide ample unused space. Therefore, the mechanical components may be spread out in this available space without creating disadvantages over a more compact design. In particular, both the sliding device and the extension/retraction device may be designed as separate entities. Although such an arrangement may take up more space compared to a perhaps more compact but mechanically complicated arrangement such as the sliding door gear of the prior art described above, this space would not otherwise have been needed. Especially in the case of sliding door gears, where movements need to be guided in a mechanically robust manner, larger dimensions and/or distances between components may provide better opportunities for more stable guidance, e.g., for larger support lengths of linear guide means.

According to a preferred variant of the invention it may be provided that, in the closed position, the movable guide segment is retracted relative to the stationary guide segment against the first opening direction, and that, in the intermediate position, the movable guide segment is aligned with the stationary guide segment.

A mechanically reliable design can be achieved if it is provided that the extension/retraction device comprises linear guide means that enable movement of the movable guide segment in and/or against the first opening direction.

Preferably, the linear guide means may comprise at least one bearing rod and at least one bearing unit. The bearing rod and the bearing unit may be linearly movable with respect to one another to form a linear bearing. A particularly smooth guidance between the bearing rod and the bearing unit may be achieved if the bearing unit is designed as a bushing, preferably a roller bushing.

A preferred embodiment of the invention may be characterized in that the extension/retraction device further comprises at least one bearing block, in that at least a part of the linear guide means, in particular the/a bearing rod or the/a bearing unit, is secured to the bearing block. The bearing block may be a sturdy part that may improve mechanical integrity of the extension/retraction device. In this context, it may be provided that that the bearing block at least partially accommodates at least a part of the linear guide means.

According to an advantageous variant of the invention it may be provided that the extension/retraction device comprises a stationary assembly to be stationary relative to the stationary structure, that the extension/retraction device comprises a movable assembly to be movable relative to the stationary structure and/or the stationary assembly in and/or against the first opening direction, and that the movable guide segment is secured to the movable assembly. In this way, the movable guide segment can be moved together with the movable assembly.

Simple and stable mounting of the stationary assembly can be achieved in that the stationary assembly comprises a cabinet mount to be fixedly mounted on the stationary structure. In this case, the stationary assembly may further comprises (the) bearing rod(s), wherein the bearing rod(s) may be secured to the cabinet mount. The movable assembly may then comprise (the) bearing block(s), wherein the bearing block(s) may be secured to the movable guide segment. A particularly robust design is achieved if at least two bearing blocks are connected to one another by means of a connecting plate.

It is conceivable that such a sliding door gear may be provided in an upper region of the stationary structure, in particular on top of a cabinet, preferably on the top wall of a cabinet. Of course, additionally or alternatively, such a sliding door gear may be provided in a lower region of the stationary structure, in particular below a cabinet, preferably on a bottom wall of a cabinet.

Alternatively, it may be provided that the stationary assembly comprises (the) bearing block(s) and preferably (the) bearing unit(s), that the bearing block(s) are to be fixedly mounted on the stationary structure, that the movable assembly comprises (the) bearing rod(s), wherein preferably at least two bearing rods are connected to one another by means of a connecting plate, and that the bearing rods are secured to the movable guide segment.

It is also conceivable for this variant to be provided in an upper region of the stationary structure, and, additionally or alternatively, to be provided in a lower region of the stationary structure.

Comfortable closing of a sliding door attached to a sliding door gear according to the invention may be achieved if a pull-in device is provided which provides a force on the door mount against the second opening direction along at least a part of the movement between the open position and the intermediate position. Preferably, the pull-in device is provided with a catching element, in particular a claw, that is displaceable relative to a housing of the pull-in device in and/or against the second opening direction. Particularly preferably, the catching element is configured to engage with a driver, which is associated with and/or moves together with the door mount.

Another advantage in terms of ease of operation can be achieved if a securing means is provided which holds the door mount in the closed position and/or biases the door mount against the first opening direction during a first part of a travel of the door mount from the closed to the intermediate position. Preferably, it may further be provided that the securing means biases the door mount in the first opening direction in a second part of the travel of the door mount from the closed to the intermediate position.

This can be achieved in a simple and reliable way if it is provided that the securing means comprises a cam part which comprises a guide cam, that the securing means further comprises a tappet which is preferably biased by a spring, in particular in a direction transverse to the first opening direction, wherein one of the cam part and the tappet is to be secured to the stationary structure or to the/a stationary assembly of the extension/retraction device in a stationary manner with respect to the first opening direction, and wherein the other one of the cam part and the tappet is secured to the movable assembly such that it moves together with the movable assembly with respect to the first opening direction, and in that, at least during parts of a movement of the door mount between the closed and the intermediate position, the tappet is in contact with and/or gets deflected by the guide cam.

In order to cater for stationary structures that are to be equipped with more than one sliding door and/or more than one type of sliding door, it is conceivable that at least one second door mount is provided for mounting at least one second sliding door to the stationary structure, that the sliding device comprises second guide means, in particular a second guide rail, on which second guide elements associated with the second door mount are guided so as to be movable in the second opening direction, such that the second door mount is movable between a second closed position and a second open position along the second opening direction.

The task regarding the stationary structure is solved by a stationary structure, such as a door frame or a piece of furniture, in particular a cabinet, comprising a sliding door gear, wherein at least one sliding door is connected to at least one door mount, wherein at least one second sliding door is connected to at least one second door mount, and wherein, when the second door mount has been moved into the intermediate position by means of the extension/retraction device, the second sliding door can be moved in and/or against the second opening direction through a gap between the sliding door and the stationary structure. Preferably, when the sliding door(s) is/are in the closed position, front planes of the sliding door(s) and second sliding door(s) are in one plane. Further preferably, the front planes are perpendicular to the first opening direction and facing away from the stationary structure.

The task of the invention is also solved by a set of sliding door gears comprising a sliding door gear to be arranged in an upper region of the stationary structure, in particular on top of a cabinet, preferably on the top wall of a cabinet, and a sliding door gear to be arranged in a lower region of the stationary structure, in particular below a cabinet, preferably on a bottom wall of a cabinet.

In this context, it may be provided that a sliding device and an extension/retraction device are provided to be arranged in the upper region of the stationary structure, and that a sliding device and an extension/retraction device are provided to be arranged in the lower region of the stationary structure, that a synchronizing device is provided to synchronize the extension/retraction devices to be arranged in the upper and the lower region of the stationary structure with one another. By these means, it may be ensured that a sliding door may be transitioned between the closed and the intermediate state both in an upper region and in a lower region in a synchronized manner.

Such a synchronization may be achieved in a particularly reliable manner, if it is provided that the synchronizing device is provided to synchronize the movement of (the) movable assemblies to be arranged in the upper region and the lower region of the stationary structure with one another, wherein preferably synchronizing is performed by means of at least one tension element of the synchronizing device, in particular a wire, most preferably a Bowden cable.

The task regarding the method for opening and/or closing a sliding door by means of a sliding door gear or a set of sliding door gears is solved by a method comprising
moving the sliding door from the closed position to the intermediate position by means of moving the movable guide segment in the first opening direction, thereby aligning the movable guide segment with the stationary guide segment,
moving the sliding door from the intermediate position to the open position along the second opening direction, thereby transitioning the first guide elements from the movable guide segment to the stationary guide segment,
   and/or
moving the sliding door from the open position to the intermediate position against the second opening direction, thereby transitioning the first guide elements from the stationary guide segment to the movable guide segment,
moving the sliding door from the intermediate position by means of moving the movable guide segment against the first opening direction, thereby retracting the movable guide segment from the stationary guide segment.

In the following, the invention will be described in more detail with reference to the figures. The figures show:

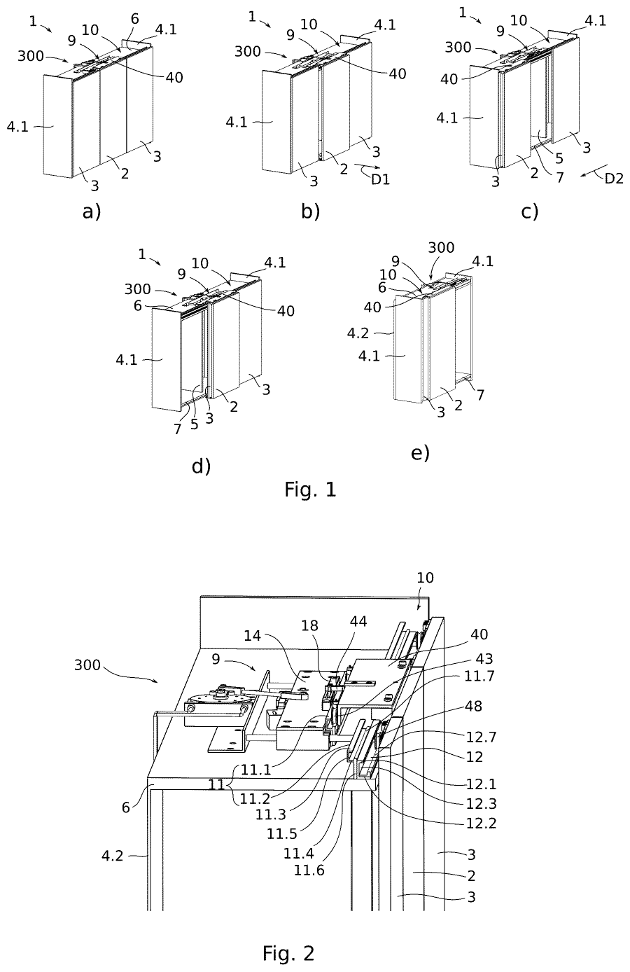

FIG. 1: schematic perspective views of cabinets 1 with sliding doors 2 and second sliding doors 3, with the sliding doors 2 in closed, intermediate and open positions,

FIG. 2: a schematic perspective view of a sliding door gear comprising an extension/retraction device 9 and a sliding device 10 mounted on top of a cabinet 1, wherein the sliding door 2 is in the closed position,

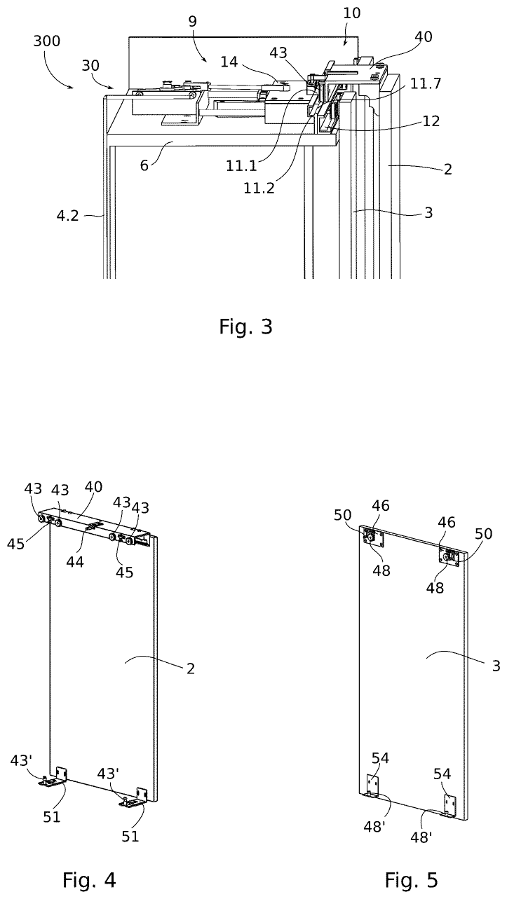

FIG. 3: a schematic perspective view of the sliding door gear of FIG. 2, wherein the sliding door 2 is in the intermediate position,

FIG. 4: a schematic perspective view of a sliding door 2 with a door mount 40 and lower door mounts 51,

FIG. 5: a schematic perspective view of a second sliding door 3 with second door mounts 46 and second lower door mounts 54,

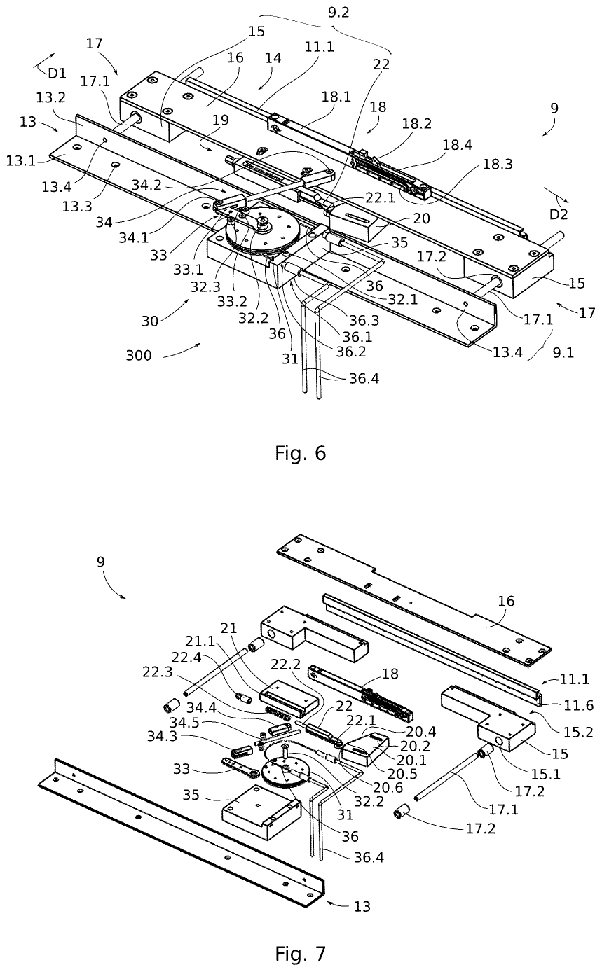

FIG. 6: a schematic perspective view of an extension/retraction device 9 and a transmission device 30 of a synchronizing device 300,

FIG. 7: a schematic exploded view of the extension/retraction device 9 and transmission device 30 of FIG. 6,

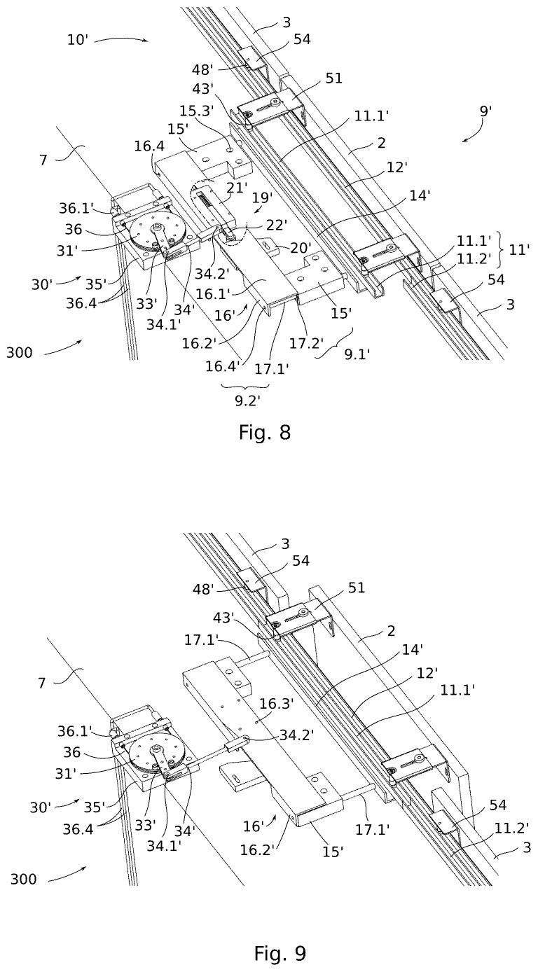

FIG. 8: a schematic perspective view of a sliding door gear comprising an extension/retraction device 9′ and a sliding device 10′ mounted on the bottom of a cabinet 1, wherein the sliding door 2 is in the closed position, and

FIG. 9: a schematic perspective view of the sliding door gear of FIG. 8, wherein the sliding door 2 is in the intermediate position.

FIG. 1 shows schematic perspective views of cabinets 1 with sliding doors 2 and second sliding doors 3 with the sliding doors 2 in closed, intermediate and open positions.

The cabinet 1 may comprise a top wall 6, a bottom wall 7, a rear wall 4.2 and/or one or more partition walls 5.

As shown in FIG. 1a) to 1d), at least one sliding door 2 may be slidably mounted to the cabinet 1. The sliding door 2 may be connected to the sliding door gear by means of a door mount 40. The sliding door gear may be mounted on the cabinet 1. For example, as shown in FIG. 1, the sliding door gear may be mounted on a top wall 6 of the cabinet 1. By means of the door mount 40 and the sliding door gear, the sliding door 2 may be mounted to the cabinet 1.

FIG. 1a) shows a closed state of the sliding door 2. In this closed state, an interior of the cabinet 1 behind the sliding door 2 may be blocked by the sliding door 2. The closed state of the sliding door 2 may correspond to a closed position of the door mount 40.

FIG. 1b) shows the sliding door 2 in an intermediate state. The intermediate state of the sliding door 2 may correspond to an intermediate position of the door mount 40. As can be seen by comparison of FIGS. 1a) and 1b), the intermediate state of the sliding door 2 may differ from the closed state in that the sliding door 2 has been moved in a first opening direction D1. Correspondingly, in the intermediate state of the sliding door 2, the door mount 40 may be in an intermediate position. From the closed position, the door mount 40 has been moved in the first opening direction D1 to reach the intermediate position.

As shown in the Figures, the first opening direction D1 may preferably be a direction facing away from the cabinet 1. The first opening direction D1 may be a direction perpendicular to a front plane of the sliding door 2.

The cabinet 1 may comprise at least one second sliding door 3. The second sliding door(s) 3 may be slidably mounted on the cabinet 1 by means of second door mounts 46 (cf. FIG. 5). The second door mounts 46 may be movable in a second opening direction D2, which may be transverse to the first opening direction D1. Preferably, as shown in the embodiment of the Figures, the second opening direction D2 may be perpendicular to the first opening direction D1.

In FIGS. 1a) to 1c) and 1e), the second sliding door(s) 3 are shown in their closed states. When the second sliding doors 3 are in their closed states, the second door mounts 46 may be in closed positions.

In FIG. 1a), both the sliding door 2 and the second sliding doors 3 are in a closed state. This may correspond to the door mount 40 and the second door mounts 46 being in their closed positions. As can be further seen in FIG. 1a), when both the sliding door 2 and the second sliding doors 3 are in the closed state, front planes of the sliding door 2 and the second sliding doors 3 may be in one plane. In other words, the sliding door 2 and the second sliding doors 3 may be arranged in line next to one another in the second opening direction D2. That is, the sliding doors may not be offset to each other in the first opening direction D1. This may provide an esthetically more pleasing appearance of a cabinet in comparison to an arrangement where sliding doors are offset relative to one another in the first opening direction D1.

Moving now to FIG. 1b), it can be seen that, when the sliding door 2 is in the intermediate state, it may be offset to the second sliding doors 3 in the first opening direction D1. This may enable moving the sliding door 2 from the intermediate state to an open state along the second opening direction D2. Open states of the sliding door 2 are shown in FIGS. 1c) and 1e). Being offset from the second sliding doors 3 in the intermediate state, the sliding door 2 may be moved across the second sliding doors 3 in front of them with respect to the cabinet 1.

Moving the sliding door 2 in and/or against the second opening direction D2 may correspond to moving the door mount 40 in and/or against the second opening direction D2. From the intermediate position, the door mount 40 may be moved in the second opening direction D2 towards an open position, which may correspond to an open state of the sliding door 2. Moving the door mount 40 in and/or against the second opening direction D2 may be enabled by a sliding device 10. The sliding device 10 will be discussed in more detail further below.

The sliding device 10 may further enable moving the second door mounts 46 in and/or against the second opening direction D2. Consequently, the second sliding doors 3 may be moved in and/or against the second opening direction D2.

As presented in FIG. 1, when the sliding door 2 is in the intermediate state, it is possible to move the second sliding doors 3 in the second opening direction D2. In particular, the second sliding doors 3 may be moved behind the sliding doors 2. Further, from the intermediate state, the sliding door 2 can be moved along the second sliding door 3 in the second opening direction D2.

The sliding device 10 can be seen in more detail in FIG. 2. Accordingly, the sliding device 10 may comprise a first guide means 11. The first guide means 11 may be a first guide rail, as in the embodiment shown. The first guide means 11 may be intended for guiding first guide elements 43, that may be associated with the door mount 40, in and/or against the second opening direction D2. In the embodiment shown, the first guide elements 43 are designed as rollers. In this case, the first guide means 11 may be designed as a guide rail comprising a rolling surface 11.7 on which the first guide elements 43 may roll in and/or against the second opening direction D2.

The sliding device 10 may further comprise second guide means 12, which may be, as in the embodiment shown, designed as second guide rails. On the second guide means 12, second guide elements 48 associated with the second door mount 46 may be guided in and/or against the second opening direction D2. Similar to the first guide elements 43, the second guide elements 48 may be designed as rollers that may roll on a rolling surface 12.7 provided on the second guide means 12.

As can further be gathered from FIG. 2, the second guide means 12 may be continuous in the second opening direction D2. For instance, the second guide means 12 may be arranged such that they cover at least the distance that one second sliding door 3 is moved between its open and closed state, and/or that the second door mounts 46 are moved between the closed and open position in and/or against the second opening direction D2. In particular, the second guide means 12 may be integrally formed covering the necessary length to accommodate opening and/closing the second sliding doors 3 and/or second door mounts 46 associated therewith.

A first guide means 11 may be designed as a rail comprising an upper wall 11.3, a side wall 11.5, a lower wall 11.4. The rolling surface 11.7 may be connected to the lower wall 11.4. Similarly, a second guide means 12 may be designed as a rail comprising upper wall 12.1, a side wall 12.3 and a lower wall 12.2. The rolling surface 12.7 may be connected to the lower wall 12.2.

The second guide means 12 may be stationary relative to the cabinet 1. For instance, and as shown in the embodiments of the Figures, the second guide means 12 may be fixed to the top wall 6 of the cabinet 1.

The second guide means 12 may be parallel to and/or offset from the first guide means 11 in the first opening direction D1.

In contrast to the second guide means 12, as seen in FIG. 2, the first guide means 11 may comprise a movable guide segment 11.1 and at least one stationary guide segment 11.2. The stationary guide segment 11.2 and the movable guide segment 11.1 may in principle be designed in the same way. Preferably, both are designed as rail segments, which together form the guide rail of first guide means 11.

The stationary guide segment 11.2 may be stationary relative to the cabinet 1. It may, for instance, be fixedly mounted on the cabinet 1, in particular on the top wall 6. In contrast, the movable guide segment 11.1 may be movable in and/or against the first opening direction D1. As seen in FIG. 2, to achieve this movability, the movable guide segment 11.1 may be coupled to an extension/retraction device 9. More details of the extension/retraction device 9 will be given further below.

In FIG. 2, a closed state of the sliding door 2 is shown. In this state, the door mount 40 may be in the closed position. The closed position of the door mount 40 may correspond to a retracted configuration of the extension/retraction device 9, as shown in FIG. 2. In the retracted configuration, the movable guide segment 11.1 may be retracted from the stationary guide segment 11.2 against the second opening direction D2.

In this state, a movement of the door mount 40 in and/or against the second opening direction D2 may not be desirable. Movement of the door mount 40 in and/or against the second opening direction D2 may be prevented on the one hand indirectly by collision of the sliding door 2 with a neighboring second sliding door 3 within the same plane. Further, the door mount 40 may be associated with a driver 44 that may be caught by a pull-in device 18 which may prevent movement of the door mount 40 in and/or against the second opening direction D2, when the door mount 40 is in the closed position. More details on the pull-in device 18 will be given further below.

An extracted configuration of the extension/retraction device 9 is shown in FIG. 3. In this configuration, the movable guide segment 11.1 may have been moved in the first opening direction D1. Consequently, the door mount 40 may have been moved in the first opening direction D1 and may now be in its intermediate position. The intermediate position of the door mount 40 may correspond to a situation in which the movable guide segment 11.1 is aligned with the stationary guide segment 11.2. Due to this alignment, the movable guide segment 11.1 and the stationary guide segment 11.2 may provide a continuous guidance of the door mount 40 and/or the first guide element 43 associated therewith in the second opening direction D2. Consequently, the door mount 40 may now be moved in the second opening direction D2. By moving the door mount 40 from the intermediate to the open position, the sliding door 2 may be moved from the intermediate to the open state.

FIG. 4 shows a schematic perspective view of a sliding door 2 with a door mount 40 and lower door mounts 51. The door mount 40 may be mounted to the sliding door 2 in any suitable manner, for example, it may be bolted, screwed, nailed and/or glued to the sliding door 2. The door mount 40 may further comprise means to allow for an adjustment of the position of the door mount 40 relative to the sliding door 2, in particular of relative height and/or lengthwise position of the door mount 40 and the sliding door 2 to one another.

The door mount 40 may further comprise retaining means 45, that may be in the shape of protrusions. The retaining means 45 may engage with the upper wall 11.3 of the first guide means 11 to prevent the first guide elements 43 from lifting off of the rolling surface 11.7.

The door mount 40 may further provide mounting means for the first guide element 43. For instance, bearing pins may be provided on the door mount 40 for bearing the first guide element 43. Further, the driver 44 mentioned before may be mounted on the door mount 40.

The door mount 40 may be mounted in an upper region of the sliding door 2. Thus, the door mount 40 may interact with a sliding device 10 and/or extension/retraction device 9 that is mounted in an upper region of the cabinet 1, for instance on a top wall 6 of the cabinet 1.

Obviously, more than one door mount 40 may be provided. For instance, one door mount 40 may be provided in a left area of the sliding door 2 and one in a right area, with left and right being opposite each other in the second opening direction D2.

A lower region of the sliding door 2 may further be equipped with a lower door mount 51. As shown in FIG. 5, more than one lower door mount 51 may be provided. However, it is conceivable to provide only one lower door mount 51. The lower door mount 51 may hold lower first guide elements 43′ that may be guided by a lower sliding device 10′. Details of the lower sliding device 10 will be given further below.

FIG. 5 provides a schematic perspective view of a second sliding door 3 with second door mounts 46 and second lower door mounts 54. As can be seen, second door mounts 46 may be provided in an upper region of the second sliding door 3, similar to what was described in context of the sliding door 2. The second door mount 46 may provide bearing means for the second guide elements 48.

The second door mount 46 may further comprise retaining means 50, that may be in the shape of protrusions. The retaining means 50 may engage with the upper wall 12.1 of the second guide means 12 to prevent the second guide elements 48 from lifting off of the rolling surface 12.7.

The second sliding door 3 may also be equipped with second lower door mounts 54 bearing lower second guide elements 48′. The lower second guide elements 48′ may be guided by the lower sliding device 10′.

Based on FIGS. 6 and 7, the extension/retraction device 9 will now be described in more detail. The extension/retraction device 9 may comprise a cabinet mount 13 which may be fixedly mounted on the cabinet 1. For instance, it may be mounted on the top wall 6 of the cabinet 1. The cabinet mount 13 may be fixed to the cabinet 1 in any suitable manner, for example by bolting, screwing and/or gluing. In the embodiment shown, the cabinet mount 13 comprises mounting bores 13.3 through which fixing elements, for example screws or bolts may be guided to engage with a part of the cabinet 1. The mounting bores 13.3 may be provided in a bottom section 13.1 of the cabinet mount 13 that may be placed, for example, on the top wall 6 of the cabinet 1.

The cabinet mount 13 may be a member of a stationary assembly 9.1 of the extension/retraction device 9. The stationary assembly 9.1 may be stationary relative to the cabinet 1, in particular with respect to the first opening direction D1.

Besides the stationary assembly 9.1, the extension/retraction device 9 may comprise a movable assembly 9.2 that is movable relative to the stationary assembly 9.1 and/or movable relative to the cabinet 1, in particular movable in and/or against the first opening direction D1. Suitable linear guide means 17 may provide for the movability of the stationary assembly 9.1.

Linear guide means 17 may comprise at least one bearing rod 17.1 and at least one bearing unit 17.2. The bearing unit 17.2 may be designed as a bushing, preferably a roller bushing. The bearing unit 17.2 may at least partially accommodate the bearing rod 17.1. The linear guide means 17 may provide a linear bearing.

As can be further seen in FIGS. 6 and 7, the movable guide segment 11.1 may be connected to and/or be part of the movable assembly 9.2. In this way, by movability o the movable assembly 9.2 in and/or against the first opening direction D1, movability of the movable guide segment 11.1 is achieved.

In the embodiment shown in FIG. 6, the movable assembly 9.2 comprises bearing blocks 15 that support the movable guide segment 11.1. The movable guide segment 11.1 may be connected to one or more bearing blocks 15 by any suitable means. Preferably, the movable guide segment 11.1 may be fixed to the bearing block 15 by screws or bolts. As is best visible in FIG. 7, bearing blocks 15 may comprise a attachment region 15.2 for attaching the movable guide segment 11.1. As in the shown embodiment, the attachment region 15.2 may be correspondingly shaped to an attachment section 11.6 of the movable guide segment 11.1.

The movable guide segment 11.1 may connect two bearing blocks 15 to one another. In other words, the movable guide segment 11.1 may be fixed to two bearing blocks 15 and thereby connect the bearing blocks 15. Additionally or alternatively, as shown in FIGS. 6 and 7, the bearing blocks 15 may be connected by means of a connecting plate 16.

The bearing blocks 15 may comprise means to secure the bearing units 17.2 to. As shown in FIG. 7, the bearing blocks 15 may comprise a bearing passage 15.1 in which a bearing unit 17.2 may be received. Preferably, the bearing passage 15.1 extends as a through hole entirely through the bearing block 15 in the first opening direction D1. In this way, the bearing rod 17.1 can pass through the bearing block 15.

The movable assembly 9.2 may thus comprise the bearing blocks 15 including the bearing unit 17.2 and the movable guide segment 11.1. In contrast, the bearing rod 17.1 may be provided in a manner stationary relative to the cabinet 1 and thus be a member of the stationary assembly 9.1.

As shown in FIGS. 6 and 7, the bearing rods 17.1 may be secured to the cabinet mount 13. For instance, the cabinet mount 13 may comprise mounting bores 13.4 that enable securing the bearing rods 17.1 to the cabinet mount 13 using screws or bolts. The mounting bores 13.4 may be provided in an angled section 13.2 of the cabinet mount 13, which may be angled off from the bottom section 13.1.

Briefly summarized, the door mount 40 (and consequently the sliding door 2) may be moved from its closed position to its intermediate position by means of the extension/retraction device 9 moving from its retracted into its extended state, thereby moving the movable assembly 9.2 relative to the stationary assembly 9.1. Consequently, the movable guide segment 11.1 is moved in the first opening direction D1, as it is connected to the movable assembly 9.2.

To secure the sliding door 2 and/or the door mount 40 in the closed position, provision may be made that the movable assembly 9.2 may be held in a retracted configuration. In the embodiment shown in the drawings, a securing means 19 is provided for this purpose.

The securing means 19 may comprise a cam part 20 and a tappet 22. The cam part 20 may comprise a guide cam (20.4, 20.5, 20.6) on which the tappet may be guided.

The tappet 22 may be biased by a spring 22.3 and supported on a base 21. For example, the base 21 may comprise a receptacle 21.1 in which the spring 22.3 and/or the tappet 22 may be at least partially received. Further, a tension adjustment 22.4 may be provided that enables the adjustment of a pretension of the spring 22.3. The tension adjustment 22.4 may be designed in a threaded manner to engage in a thread provided on the base 21 such as to be adjustable in position relative to the base 21.

The spring 22.3 may be a compression spring providing a spring force facing away from the base 21. The spring 22.3 may be at least partially supported on an end section 22.2 of the tappet 22 facing toward the base 21.

The cam part 20, the tappet 22 and/or the base 21 may be arranged such that the tappet 22 and/or the force of the spring 22.3 is/are oriented in a direction towards the cam part 20. Preferably, as shown in the drawings, this direction is perpendicular, or at least has a component perpendicular to the first opening direction D1. The tappet 22 may comprise, on its end facing the cam part 20, a roller 22.1.

In the embodiment of the drawings, the cam part 20 is secured to the cabinet 1. In this case, the base 21 supporting the tappet 22 may be secured to the movable assembly 9.2. For instance, it may be secured to the connecting plate 16 as illustrated in FIG. 6. Of course, a reverse arrangement is conceivable.

When the door mount 40 is in the intermediate position, and therefore the movable assembly 9.2 is extended, the tappet 22, in particular the roller 22.1 may or may not be in contact with the cam part 20. However, when the door mount 40 is moved from its intermediate position against the first opening direction D1, i.e. during retraction of the movable assembly 9.2, the tappet 22 may come into contact with the cam part 20. In particular, during a first part of the movement, the roller 22.1 may roll on a deflection region 20.4 of the guide cam of the cam part 20. The deflection region 20.4 may be inclined with respect to the first opening direction D1 such that during retraction of the movable assembly 9.2 a force is acting on the tappet 22 against the direction of the force of the spring 22.3.

Adjacent to the deflection region 20.4, a turning point 20.5 may be provided. From the turning point 20.5 onward against the first opening direction D1, the tappet 22 may be guided on a resting region 20.6, that may have an inclination opposite to that of the deflection region 20.4. The tappet 22 may be in contact with this resting region 20.6 when the retraction is almost complete and/or the closed/retracted position is achieved.

It will be appreciated that, in such an arrangement, during a first part of moving the door mount 40 from the intermediate to the closed position, a force must be applied to the door mount 40 against the first opening direction D1 to overcome the force of the spring 22.3. During this part, the tappet 22 is in contact with the deflection region 20.4. During a second part of moving, the force of the spring 22.3 will aid the movement of the door mount 40 to the closed position. This is once the turning point 20.5 has been transcended and the tappet 22 is in contact with and guided on the resting region 20.6. Obviously, the reverse is true for moving the door mount 40 from the closed to the intermediate position, and/or moving the movable assembly 9.2 from the retracted to the extended configuration.

As can be further seen in FIG. 7, the cam part 20 may be provided with alignment means 20.2. The alignment means 20.2 may be slots that enable adjusting the position of the cam part 20. In this way, the alignment of the cam part 20 relative to the tappet 22 and/or the base 21 can be adjusted. This may be an alternative or additional means to the tension adjustment 22.4 mentioned before, to adjust the force necessary to close the sliding door 2 and/or the force available to hold it in the closed position, and/or the force provided for pushing it into the intermediate position.

As previously indicated, a pull-in device 18 may be provided. The pull-in device 18 may provide a force on the door mount 40 against the second opening direction D2 once the driver 44 has come into engagement therewith.

As shown in FIG. 6, the pull-in device 18 may comprise a housing 18.1. The pull-in device 18 may further comprise a catching element 18.2 that is displaceable relative to the housing 18.1. Preferably, and as in the embodiment shown, the catching element 18.2 is configured as a claw.

The catching element 18.2 may be biased against the second opening direction D2 by means of a spring. For example, a tension spring may be provided within the housing 18.1. In addition to being displaceable with respect to the housing 18.1, the catching element 18.2 may be pivotable about an axis that may preferably be perpendicular to the second opening direction D2. In that way, pivoting of the catching element 18.2 may selectively enable catching, holding and releasing the driver 44. For this purpose, the housing 18.1 may comprise a guide slot 18.3 in which a guide element of the catching element 18.2 may be guided. The guide slot 18.3 may be configured such that the catching element 18.2 is pivoted into a position for releasing the driver 44 after a certain displacement in the second opening direction D2. In this position, the catching element 18.2 may be ready to again catch the driver 44 upon a closing event.

So far, details of a sliding door gear to be arranged in an upper section, in particular on the top wall 6, of the cabinet 1 have been described. It may be sufficient for some purposes to only provide a sliding door gear for mounting sliding doors from above. In some cases, it may be desirable, however, to at least support the lower part of the sliding doors to some degree in the first opening direction D1. In such cases, a support mechanism as disclosed in WO 2021/173088 A1 may be provided in a lower region, for instance at a side wall 4.1 or a partition wall 5 of the cabinet 1.

However, improved guidance of the sliding door 2 may be achieved if, in addition to an upper sliding door gear to be arranged in an upper region of the cabinet 1, a lower sliding door gear to be arranged in a lower region of the cabinet 1 is provided. For instance, the lower sliding door gear may be arranged below the cabinet 1, preferably on the bottom wall 7 of the cabinet 1.

The lower sliding door gear may comprise similar components and be similarly arranged as the upper sliding door gear. In particular, the lower sliding door gear may be, at least in parts, a mirror image of the upper sliding door gear.

However, the lower sliding door gear may be, at least in some aspects, designed and/or arranged differently than the upper sliding door gear. For instance, the lower sliding door gear may be as shown in FIGS. 8 and 9.

Similar components of the lower sliding door gear are given similar reference numbers as the ones of the upper door gear, where reference numbers of the lower sliding door gear components are appended with a prime symbol (′). For example, a lower extension/retraction device is referenced by 9′, a lower sliding device by 10′ and so on.

Structure and function of the lower sliding door gear shown in FIGS. 8 and 9 largely correspond to the upper sliding door gear. In this respect, reference can be made to the above statements in order to avoid repetition. Discussion of the lower sliding door gear will be reduced to aspects differing from the upper sliding door gear.

As can be seen in FIGS. 8 and 9, the lower extension/retraction device 9′ may also comprise bearing blocks 15′. However, in contrast to the bearing blocks 15 of the upper extension/retraction device 9 discussed above, the bearing blocks 15′ may be stationary. For instance, they may be fixed to the cabinet 1, in particular to the bottom wall 7. For this purpose, they may comprise attachment bores 15.3 through which appropriate fixing means, for example screws of bolts may be guided. Consequently, the bearing blocks 15′ may be considered to be a part of a stationary assembly 9.1′ of the lower extension/retraction device 9′.

Further, in contrast to the linear guide means 17 of the upper sliding door gear, the linear guide means 17′ of the lower sliding door gear may be arranged such that the bearing rods 17.1′ are movable with respect to the cabinet 1.

As shown in FIGS. 8 and 9, they may be secured to the movable guide segment 11.1. In particular, the bearing rod 17.1 may be secured to a movable carrier 14′ that the movable guide segment 11.1 may be secured to. At an opposite end, the bearing rod 17.1′ may be secured to a connecting plate 16′.

The connecting plate 16′ may comprise a bottom section 16.1′ and an angled section 16.2′. The angled section 16.2′ may comprise mounting bores 16.4′, through which fixing elements, for example bolts, may be guided to secure the bearing rods 17.1′ to the connecting plate 16′.

In FIG. 8, for better visibility, the bottom section 16.1′ of the connecting plate 16′ is partially cut away in the region of the base 21′ of the securing means 19′. As can be gathered from this illustration and FIG. 9, the base 21′ may be secured to the connecting plate 16′, preferably to the bottom section 16.1′. For instance, the bottom section 16.1′ may comprise mounting bores 16.3′ to enable fixing the connecting plate 16′ to the base 21′ by screws, bolts, or any other suitable fixing means.

Summarizing, the main differences between the upper sliding door gear of FIGS. 2, 3, 6 and 7 and the lower sliding door gear of FIGS. 8 and 9 have been highlighted. However, some or all aspects of the lower sliding door gear of FIGS. 8 and 9 may be applied to the upper sliding door gear and vice versa.

Especially in the case where an upper and a lower sliding door gear are provided, it may be desired to provide for synchronization of movements of the upper and the lower sliding door gear. In particular, it may be desired to synchronize movement of an upper door mount 40 and a lower door mount 51 in the first opening direction D1.

For this purpose, a synchronizing device 300 may be provided. Referring to FIGS. 6 and 7, the synchronizing device 300 may comprise a transmission element 31. The transmission element 31 may preferably be designed as a pulley and may preferably be rotatably mounted by means of a shaft 32.2. On an outer circumference, the transmission element 31 may comprise a groove 32.1 in which a flexible transmission member 36 may be guided.

The transmission element 31 may be stationarily mounted with respect to the stationary assembly 9.1 and/or with respect to the cabinet 1. Preferably, the transmission element 31 may be mounted on a mounting block 35. As shown in the Figures, the mounting block 35 may be secured to a member of the stationary assembly 9.1, for example to the cabinet mount 13. It is conceivable, however, that the mounting block 35 may be mounted directly on the cabinet 1, for example, directly fixed to the top wall 6.

At least one flexible transmission member 36 may be secured to the transmission element 31. In the embodiment of the Figures, two flexible transmission members 36 are provided each of which secured to the transmission element 31 by means of a clamping means 32.3. As shown in the Figures, the flexible transmission members 36 may preferably be wires.

The flexible transmission members 36 may be guided from the upper sliding door gear (FIGS. 6 and 7) to the lower sliding door gear (FIGS. 8 and 9). For instance, the flexible transmission members 36 may be guided in cable housings 36.4 extending between the upper and the lower sliding door gear. Preferably, the flexible transmission members 36 may be guided from the upper to the lower sliding door gear behind the cabinet 1, in particular behind and/or along a rear wall 4.2 of the cabinet 1.

As can be seen in FIG. 6, the transmission element 31 may be connected to a transmission lever 33. The transmission lever 33 may be fixedly secured to the transmission element 31 so as to be rotatable together with the transmission element 31. As shown in FIG. 6, the transmission lever 33 may be secured to the transmission element 31 in the region of the shaft 32.2 and in a region closer to an outer circumference of the transmission element 31. For instance, it may be secured to the transmission element 31 close to the outer circumference by means of a fixing element 33.2, for instance by a bolt or a screw.

The transmission lever 33 may be pivotably connected to a connecting lever 34 at a first pivot point 34.1. At a second pivot point 34.2, the connecting lever 34 may be pivotably connected to a member of the movable assembly 9.2 of the extension/retraction device 9. As in the embodiment shown, the connecting lever 34 may be pivotably connected to the connecting plate 16.

By means of the connecting lever 34 and the transmission lever 33, a movement of the movable assembly 9.2, in particular a movement in the first opening direction D1, can be transmitted to the transmission element 31. As in the embodiment shown, a movement of the movable assembly 9.2 may be translated into a rotation of the transmission element 31.

With the flexible transmission members 36 being secured to the transmission element 31, a rotation of the transmission element 31 may be translated into a movement of the flexible transmission members 36 and/or in a force transmitted to the flexible transmission members 36.

In particular, a movement of the movable assembly 9.2 in the first opening direction D1, corresponding to a movement of the door mount 40 from the closed to the intermediate position, may result in a tensile (pulling) force in one of the flexible transmission members 36. The other one of the flexible transmission members 36 may be subjected to a compressive (pushing) force. Clearly, an opposite movement of the movable assembly 9.2 against the first opening direction D1 may result in in opposite directions of the forces, respectively.

The assembly comprising the mounting block 35, the transmission element 31, the transmission lever 33 and the connecting lever 34 may be called a transmission device 30.

Referring now to FIGS. 8 and 9, it is shown that a lower transmission device 30′ similar to the transmission device 30 discussed above may be associated with the lower sliding door gear. The lower transmission device 30′ may be made up of similar components and may function in a similar way to the upper transmission device 30. Similar components of the lower transmission device 30′ are again given similar reference numbers as the ones of the upper transmission device 30, where reference numbers of the lower transmission device's 30′ components are appended with a prime symbol (′).

It will be appreciated that movements and forces translated from the upper extension/retraction device 9 to the flexible transmission members 36 via the upper transmission device 30 will be transmitted to the lower extension/retraction device 9′ by the lower transmission device 30′ and vice versa. Therefore, the synchronizing device 300 may synchronize movements of the upper and the lower extension/retraction devices 9, 9′ and, consequently, of the upper and lower door mounts 40, 51.

Turning back to FIGS. 6 and 7, the connecting lever 34 may comprise a first end part 34.3, a second end part 34.4 and a rod part 34.5 arranged therebetween. The first pivot point 34.1 may be associated with the first end part 34.3 and/or the second pivot point 34.2 may be provided on the second end part 34.4. By adjusting the relative lengthwise position of the first end part 34.3 and the second end part 34.4 to one another, the length of the connecting lever 34 and/or the distance between the pivot points 34.1, 34.2 may be adjusted.

The lengthwise adjustment of the first end part 34.3 and the second end part 34.4 to one another may be achieved by means of a threaded engagement. For instance, the first end part 34.3 and/or the second end part 34.4 may comprise a threaded receptacle to receive a section of the rod part 34.5, wherein the rod part 34.5 may be or comprise a threaded rod. Thereby, a rotation of one or both of the end parts 34.3, 34.4 relative to the rod part 34.5 may provide lengthening and/or shortening of the connecting lever 34.

By adjusting the length of the connecting lever 34 and/or of the distance between the pivot points 34.1, 34.2, adjustment of the synchronization of the upper and the lower sliding door gear may be achieved.

Further, the transmission lever 33 may be designed to comprise more than one attachment point 33.1 spaced to one another, to which the connecting lever 34 may be selectively connected at the first pivot point 34.1. This may provide additional or alternative adjustment options.

As can be seen in FIGS. 8 and 9, the lower connecting lever 34′ and/or transmission lever 33′ may be designed similarly and may thus provide supplementary or alternative adjustment options.

The cable housings 36.4 of one or both of the flexible transmission members 36 may be provided with adjusters 36.1, 36.1′, which may be provided on one or both ends facing the upper and/or the lower transmission device 30, 30′. The adjusters 36.1, 36.1′ may be used to alter the path length that the flexible transmission member 36 needs to cover between the upper and the lower sliding door gear. By altering the length of the path of the flexible transmission member 36, a pretension of the flexible transmission member 36 may be adjusted. Preferably, the cable housings 36.4 are rigid and/or at least substantially incompressible in the lengthwise direction.

As shown in the Figures, the adjusters 36.1 may preferably be designed as barrel adjusters, through which the flexible transmission members 36 may be guided. The adjusters 36.1, 36.1′ may comprise a threaded section 36.2 that may be at least partially received in a threaded bore of the mounting block 35. By rotating the adjusters 36.1, 36.1′, a distance of the cable housing 36.4 to the mounting block 35 and thus to the transmission element 31 and/or the clamping means 32.3 may be adjusted. Hence, the path length to be covered by the flexible transmission member 36 may be changed.

Such a design of a flexible transmission member 36 guided within a cable housing 36.4, preferably further comprising a adjuster 36.1, 36.1′ designed as a barrel adjuster, may be called a Bowden cable.

The following describes the operation of the sliding door gear in more detail.

At first, a sliding door 2 and/or second sliding doors 3 may be in the closed state, as shown in FIGS. 1a) and 2. In this state, the door mount 40 and the lower door mounts 51 may be in the closed position. Further, the extension/retraction devices 9, 9′ of the upper and the lower sliding door gear may be in the retracted configuration.

A user wishing to open the sliding door 2 may now move the sliding door 2 into the intermediate state, whereby the door mount 40 and the lower door mounts 51 are moved into the intermediate position, and the extension/retraction devices 9, 9′ are moved to the extended configuration. Movement of the upper and lower movable assemblies 9.2 may be synchronized by the synchronizing device 300.

This may be achieved simply by the user pulling the sliding door 2 in the first opening direction D1. For example, a handle may be provided on the sliding door 2. Alternatively, a push-to-open mechanism may be provided, that may provide automatic movement of the sliding door 2 in the first opening direction D1 once a sufficient overtravel has been performed on the sliding door 2 by the user against the first opening direction D1.

Now the movable guide segments 11.1, 11.1′ may be aligned with the corresponding stationary guide segments 11.2, 11.2′, so that the first guide elements 43, 43′ can be guided from the movable guide segment 11.1, 11.1′ over to the stationary guide segments 11.2, 11.2′. This means that the door mount 40 and the lower door mounts 51 may now be moved from the intermediate position to the open position in the second opening direction D2.

The sliding door 2 can now be moved by the user from the intermediate state to the open state. It is conceivable that the user simply pushes the sliding door 2 in the second opening direction D2. However, a self-opening mechanism may be provided, for example comprising an electric motor and/or a spring loaded element urging the sliding door 2 in and/or against the second opening direction D2.

Further, the second sliding doors 3 may be moved in the second opening direction D2, now that the sliding door 2 in the intermediate and/or open state, as can be seen in FIG. 1d). The second sliding door 3 may be moved in between the cabinet 1 and the sliding door 2 through a gap that results from extending the door mount 40, the stationary assembly 9.1 and/or the sliding door 2 in the first opening direction D1.

Closing the sliding door 2 may be performed in the opposite way to that described for opening.

1-16. (canceled)

17: A sliding door gear, comprising:
at least one door mount configured to mount at least one sliding door to a stationary structure;
a sliding guide including a first guide rail including a movable guide segment and at least one stationary guide segment, the first guide rail being configured to receive a first guide element of the at least one door mount; and
an extension/retraction guide coupled to the movable guide segment to enable movement of the movable guide segment in a first opening direction wherein the at least one door mount moves from a closed position to an intermediate position;
wherein the sliding guide is configured such that the at least one door mount can be moved from the intermediate position to an open position in a second opening direction transverse to the first opening direction.

18: The sliding door gear of claim 17, wherein:
in the closed position the movable guide segment is retracted relative to the stationary guide segment against the first opening direction; and
in the intermediate position the movable guide segment is aligned with the stationary guide segment.

19: The sliding door gear of claim 17, wherein:
the extension/retraction guide includes a linear guide configured to guide a linear movement of the movable guide segment in and/or against the first opening direction.

20: The sliding door gear of claim 19, wherein:
the linear guide includes at least one bearing rod and at least one bushing, the at least one bearing rod and the at least one bushing being linearly movable relative to each other to form a linear bearing.

21: The sliding door gear of claim 20, wherein:
the extension/retraction guide includes at least one bearing block; and
the at least one bearing rod or the at least one bushing of the linear guide is secured to the at least one bearing block.

22: The sliding door gear of claim 17, wherein:
the extension/retraction guide includes a stationary assembly configured to be attached to the stationary structure and a movable assembly configured to be movable relative to the stationary structure in and/or against the first opening direction; and
the movable guide segment is secured to the movable assembly.

23: The sliding door gear of claim 22, wherein:
the stationary assembly includes a cabinet mount configured to be fixedly mounted on the stationary structure;
the stationary assembly further includes at least one bearing rod secured to the cabinet mount; and
the movable assembly includes at least two bearing blocks secured to the movable guide segment, the at least two bearing blocks being connected to one another by a connecting plate.

24: The sliding door gear of claim 22, wherein:
the stationary assembly includes at least one bearing block configured to be fixedly mounted on the stationary structure; and
the movable assembly further includes at least two bearing rods secured to the movable guide segment, the at least two bearing rods being connected to one another by a connecting plate.

25: The sliding door gear of claim 17, further comprising:
a pull-in device configured to provide a force on the door mount against the second opening direction along at least a part of a movement between the open position and the intermediate position, the pull-in device including a housing and a claw displaceable relative to the housing in and/or against the second opening direction;
wherein the at least one door mount includes a driver; and
wherein the claw is configured to engage with the driver.

26: The sliding door gear of claim 17, further comprising:
a resilient latch configured to bias the at least one door mount against the first opening direction during a first part of a travel of the at least one door mount from the closed position to the intermediate position.

27: The sliding door gear of claim 26, wherein:
the resilient latch is further configured to bias the at least one door mount in the first opening direction during a second part of the travel of the at least one door mount from the closed position to the intermediate position.

28: The sliding door gear of claim 27, wherein:
the extension/retraction guide includes a stationary assembly configured to be attached to the stationary structure and a movable assembly configured to be movable relative to the stationary structure in and/or against the first opening direction;
the movable guide segment is secured to the movable assembly;
the resilient latch includes a guide cam, a tappet and a spring biasing the tappet in a direction transverse to the first opening direction;
one of the guide cam and the tappet is mounted on the stationary assembly in a stationary manner with respect to the first opening direction;
the other of the guide cam and the tappet is mounted on the movable assembly so as to move together with the movable assembly in the first opening direction; and
during at least part of a movement of the at least one door mount between the closed position and the intermediate position the tappet is in contact with the guide cam.

29: The sliding door gear of claim 17, further comprising:
at least one second door mount configured to mount at least one second sliding door to the stationary structure;
wherein the sliding guide includes a second guide rail configured to receive a second guide element of the at least one second door mount; and
wherein the at least one second door mount is movable between a second closed position and a second open position along the second opening direction.

30: The sliding door gear of claim 29, in combination with at least one sliding door connected to the at least one door mount and at least one second sliding door connected to the at least one second door mount, wherein when the at least one door mount is in the intermediate position the at least one second sliding door can be moved in and/or against the second opening direction through a gap between the at least one sliding door and the stationary structure, and when the at least one sliding door is in the closed position a front plane of the at least one sliding door and a front plane of the at least one second sliding door are in one plane.

31: The sliding door gear of claim 17 being a first sliding door gear, in combination with a second sliding door gear, wherein the first sliding door gear is mounted in an upper region of the stationary structure and the second sliding door gear is mounted in a lower region of the stationary structure.

32: The sliding door gear of claim 31, wherein:
the sliding guide and the extension/retraction guide of the first sliding door gear are arranged in the upper region of the stationary structure;
the second sliding door gear includes a second sliding guide and a second extension/retraction guide arranged in the lower region of the stationary structure; and
further including a synchronizer configured to synchronize movement of the extension/retraction guides of the first and second sliding door gears with each other.

33: A method of opening and/or closing a sliding door using a sliding door gear, the sliding door gear including:
at least one door mount mounting the sliding door to a stationary structure;
a sliding guide including a first guide rail including a movable guide segment and at least one stationary guide segment, the first guide rail receiving a first guide element of the at least one door mount; and
an extension/retraction guide coupled to the movable guide segment to enable movement of the movable guide segment in a first opening direction wherein the at least one door mount and the sliding door moves from a closed position to an intermediate position;
the method comprising:
moving the sliding door from the closed position to the intermediate position by moving the movable guide segment in the first opening direction, thereby aligning the movable guide segment with the stationary guide segment; and
moving the sliding door from the intermediate position to an open position along a second opening direction transverse to the first opening direction thereby transitioning the first guide element from the movable guide segment to the stationary guide segment.

34: The method of claim 33, further comprising:
moving the sliding door from the open position to the intermediate position against the second opening direction thereby transitioning the first guide element from the stationary guide segment to the movable guide segment; and
moving the sliding door from the intermediate position by moving the movable guide segment against the first opening direction thereby retracting the movable guide segment from the stationary guide segment.
